(19) United States
(12) Patent Application Publication
(10) Pub. No.: US 2019/0150475 A1
(43) Pub. Date: May 23, 2019

(54) A PROCESS FOR PREPARING A SHELF-STABLE PROTEIN SNACK

(71) Applicant: NESTEC S.A., Vevey (CH)

(72) Inventor: Albert Kurnia, Konstanz (DE)

(21) Appl. No.: 16/091,289

(22) PCT Filed: Apr. 3, 2017
(86) PCT No.: PCT/EP2017/057870

§ 371 Date: Oct. 4, 2018

(30) Foreign Application Priority Data
Apr. 6, 2016 (EP) 16163957.0

(51) Int. Cl. A23J 3/14; A23K 10/30; A23K 50/42; A23J 3/22

(52) U.S. Cl. CPC A23J 3/14; A23J 3/227; A23K 50/42; A23K 10/30

(57) ABSTRACT

The invention relates to a process for preparing a shelf-stable protein snack. More specifically the invention relates to a process for preparing a shelf-stable protein snack with a fibrous appearance and a crunchy texture, characterised in that the process is completely free of an extrusion step. The invention relates also to the shelf-stable protein snack obtained by the process.

### TECHNICAL FIELD

The invention generally relates to a process for preparing a shelf-stable protein snack. More specifically the invention relates to a process for preparing a shelf-stable protein snack with a fibrous appearance and a crunchy texture.

### BACKGROUND

In recent years, it has become common for consumers to choose foods that are convenient and tasty. However, convenient or ready-to-eat foods tend to be nutritionally unbalanced as they are high in fat and short-chain carbohydrates e.g. refined sugars, and low in dietary fiber and protein. In particular, it is appreciated that the high fat and low dietary fiber level of these convenient foods can contribute to obesity and various chronic diseases, such as coronary heart disease, stroke, diabetes, and certain types of cancer. It is well known that the primary nutritional features of meat is its protein content. However, the production of meat is relatively inefficient in terms of feed input to food output. Accordingly, high protein snacks can achieve a desired protein content using inexpensive by-products from certain crops such as soybeans. Furthermore, some individuals abstain from the consumption of meat for any of a variety of reasons. Moreover, many pet owners feed or wish to feed meatless diets to their companion animals.

It is well known that by supplementing foods with increased levels of dietary fiber and protein, taste can be seriously compromised as off-flavors result in a chalky and bland taste. In addition to the challenges associated with improving taste, it is known that increasing a food's protein level typically results in the loss of the desirable product texture that consumers expect. This is especially critical for snack foods. The loss of desirable texture typically results in products, such as high protein and fiber health bar snacks that are described by consumers as having an unpleasant stickiness and/or grittiness.

Hence, there is an existing need in the art and industry to provide a better solution for shelf-stable protein snacks for humans or animals such as pets having a fibrous appearance with a crunchy texture. The shelf-stable protein snacks for humans or animals such as pets having a fibrous appearance as dried real meat with a crunchy texture. There are no shelf-stable protein snacks on the market having such fibrous appearance as dried real meat with a crunchy texture.

### SUMMARY OF THE INVENTION

The object of the present invention is to improve the state of the art or at least provide an alternative for a shelf-stable protein snacks: i) a shelf-stable protein snack for humans or animals such as pets; ii) a shelf-stable protein snack with a high protein content; iii) a shelf-stable protein snack with a protein content above 40 wt %; iv) a shelf-stable protein snack having a fibrous appearance with a crunchy texture; v) a shelf-stable protein snack having a fibrous appearance as dried real meat; vi) a shelf-stable protein snack having a fibrous appearance having starch or starch flour in a low amount; vii) a shelf-stable protein snack having a fibrous appearance without having starch or starch flour; viii) a shelf-stable protein snack having a fibrous appearance having plant lipid in the resulting snack using starch or starch flour in a low amount; ix) a shelf-stable protein snack having a fibrous appearance having plant lipid in the resulting snack without using starch or starch flour; x) a shelf-stable protein snack having a crunchy texture; xi) a shelf-stable protein snack having a fibrous appearance as dried real meat with a crunchy texture.

The object of the present invention is achieved by the subject matter of the independent claims. The dependent claims further develop the idea of the present invention.

Accordingly, the present invention provides in a first aspect a process for preparing a shelf-stable protein snack comprising the steps of: mixing dry and wet ingredients comprising plant protein and water to form a non-meat dough; heating the non-meat dough under pressure; cooling, cutting and drying the heated non-meat dough.

In a second aspect, the invention pertains to a shelf-stable protein snack product obtainable by the process comprising the steps of: mixing dry and wet ingredients comprising plant protein and water to form a non-meat dough; heating the non-meat dough under pressure; cooling, cutting and drying the heated non-meat dough.

In a third aspect, the invention provides a method for preparing a shelf-stable protein snack comprising the steps of: mixing dry and wet ingredients comprising plant protein and water to form a non-meat dough; heating the non-meat dough under pressure; cooling, cutting and drying the heated non-meat dough.

It has been surprisingly found by the inventors that by using the above mentioned process a shelf-stable protein snack having a fibrous appearance and a crunchy texture can be obtained. Due to the fibrous appearance the obtained vegetarian shelf-stable protein snack looks similar to dried real meat.

### DETAILED DESCRIPTION

The processes of the present invention allow the continuous production of a shelf-stable protein snack product that have the fibrous appearance without the use of extrusion. High shear heating or another heating method can be used in conjunction with non-meat proteins to produce a realistic-looking dried non-meat product. The texturized dried products produced from these processes can be further enhanced by adding flavouring systems, coloring, and/or texturization agents and can be fortified to improve the nutritional value of the product.

Accordingly, in a general embodiment, the present invention provides a process comprising: mixing dry and wet ingredients comprising plant protein and water to form a non-meat dough (101); heating the non-meat dough under pressure (103); cooling (105), cutting (106) and drying (107) the heated non-meat dough.

In an embodiment, the heated non-meat dough undergoes gradually decreasing pressure during the cooling (105).

In an embodiment the cooling is a gradually cooling.

In an embodiment, the process comprises pumping (102) the non-meat dough from a device that performs the mixing (101) to a device that performs the heating (103), without any processing there between.

In an embodiment, the process comprises maintaining the pressure on the heated non-meat dough during transfer (104) from a device that performs the heating (103) to a device that performs the cooling (105), without any processing there between.

In an embodiment, the mixing (101) is performed by a batch or continuous mixer.

In an embodiment, the heating (103) is performed by a device selected from the group consisting of a high shear emulsifier, a heat exchanger, and a dielectric heater.

In an embodiment, the non-meat dough is an emulsion.

In an embodiment, the non-meat dough resulting from the mixing has a moisture content of 40% to 67%.

In an embodiment, the dry ingredients comprise plant protein in an amount of 15% to 45%, preferably 15% to 35%, relative to the non-meat dough resulting from the mixing.

In an embodiment, the wet ingredients comprise plant lipid in an amount of 0% to 14%, preferably 0.1 to 14%, preferably 0.5% to 10%, preferably 2% to 10%, relative to the non-meat dough resulting from the mixing. Plant lipid is selected from the group of liquid oil, liquid fat or combination thereof.

In an embodiment, plant lipid is selected from the group consisting of soybean oil, corn oil, sunflower oil, high oleic sunflower oil, olive oil, canola oil, safflower oil, peanut oil, palm oil, cottonseed oil, coconut oil, almond oil, hazelnut oil, grapeseed oil, or combinations thereof.

In an embodiment, the shelf-stable protein snack has a protein content above 40 wt %, preferably between 40 to 80 wt %.

In an embodiment, the heating (103) is performed at a temperature of 110° C. to 180° C., preferably at a temperature of 125° C. to 180° C.

In an embodiment, the non-meat dough undergoes the heating while at a pressure from 4.5 bar to 35 bar.

In an embodiment, the dry ingredients comprise starch or starch flour.

In an embodiment, the cooling is performed by a heat exchanger.

An advantage of the present invention is to provide dried non-meat food products that have a more realistic fibrous dried meat-like appearance to real dried meat products with a crunchy texture. Another advantage of the present invention is to provide a shelf-stable protein snack that have a realistic fibrous appearance as dried real meat a crunchy texture. Another advantage of the present invention is to allow product nutritional profiles to be tailored to different market segments.

Still another advantage of the present invention is to allow the development of new products for the vegan, vegetarian and health food markets.

An additional advantage of the present invention is to improve the textural attributes of dried non-meat food products.

Another advantage of the present invention is to increase the palatability of dried non-meat food products.

Yet another advantage of the present disclosure is to provide dried non-meat food products that have greater appeal for humans.

Another advantage of the present invention is to provide non-meat food products that have greater appeal for pets.

Yet another advantage of the present disclosure is to provide a shelf-stable protein snack product that has a very realistic, fibrous and meat-like appearance.

Another advantage of the present invention is to provide a shelf-stable protein snack that is crunchy and is not pasty or mushy.

Additional features and advantages are described in, and will be apparent from, the following Detailed Description and the Figures.

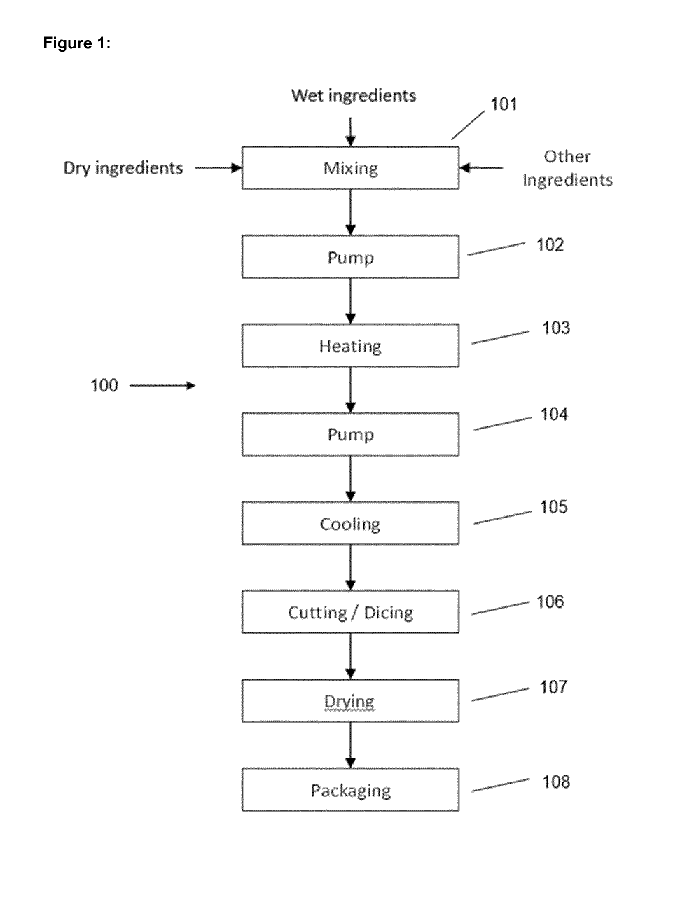

FIG. 1 is a flowchart showing an embodiment of a method provided by the present disclosure.

All percentages expressed herein are by weight of the total weight of the composition unless expressed otherwise. When reference is made to the pH, values correspond to pH measured at 25° C. with standard equipment.

The terms “food,” “food product” and “food composition” mean a product or composition that is intended for ingestion by an animal, including a human, and provides at least one nutrient to the animal. The present disclosure is not limited to a specific animal. The term “pet food” means any composition intended to be consumed by a pet.

The term “pet” means any animal which could benefit from or enjoy the compositions provided by the present disclosure. For example, the pet can be an avian, bovine, canine, equine, feline, hicrine, lupine, murine, ovine, or porcine animal, but the pet can be any suitable animal. The term “companion animal” means a dog or a cat.

A “non-meat” food product is a composition in which meat (i.e. skeletal tissue and non-skeletal muscle from mammals, fish and fowl) and meat by-products (i.e. the non-rendered clean parts, other than meat, derived from slaughtered mammals, fowl or fish) are completely absent.

By “shelf-stable” is meant that the said protein snack can be safely stored at room temperature in a sealed pack. Particularly, the protein snack can be safely stored for at least 2 months, preferably for at least 6 months, preferably for at least 9 months, more preferably for at least 12 months at a room temperature of 25° C. Within the said shelf-stable period, the protein snack maintains its organoleptic stability as well as its microbiological safety. During that period the protein snack remains its described fibrous appearance and crunchy texture functionality.

As generally illustrated in FIG. 1, the present invention provides a process 100 for producing a fibrous shelf-stable protein snack (dried non-meat product) with the appearance of dried meat and a crunchy texture. The process 100 can comprise (i) mixing dry and wet ingredients comprising plant protein and water to form a non-meat dough (101); (ii) heating the non-meat dough under pressure in a heating device (103); and (iii) maintaining the pressure on the hot non-meat dough during transfer (104) from the heating device (103) to a cooling device (105); and (iv) cooling the non-meat dough (105), preferably while reducing the pressure, to form a fibrous slab of meaty appearance which is cut (106) and dried (107).

More specifically with respect to FIG. 1, the process 100 can comprise mixing the dry ingredients with wet ingredients in a mixing device to form a non-meat dough in Step 101. Preferably the mixing device is a batch or continuous mixer. The dry ingredients comprise plant protein, and the wet ingredients comprise water. In an embodiment, the resultant non-meat dough has a moisture content of 40% to 67%, preferably 45% to 65%.

The term “plant protein” include pea protein, corn protein (e.g., ground corn or corn gluten), wheat protein (e.g., ground wheat or wheat gluten such as vital wheat gluten), legume protein such as soy protein (e.g., soybean meal, soy concentrate, or soy isolate), rice protein (e.g., ground rice or rice gluten) and combinations thereof. If flour is used, it will also provide some protein. Therefore, a material can be used that is both a vegetable protein and a flour. Preferably, the dry ingredients comprise plant protein in an amount of 15% to 45% of the total mixture (dry+wet ingredients), preferably 15% to 35% of the total mixture.

The dry ingredients can comprise an ingredient that is a starch flour. Non-limiting examples of suitable starch flours include cereal flours, such as those from rice, wheat, corn, barley, and sorghum; root vegetable flours, such as those from potato, cassava, sweet potato, arrowroot, yam, and taro; and other flours, such as sago, banana, plantain, and breadfruit flour. Preferably, the dry ingredients comprise the starch flour in an amount of 0% to 15% of the total mixture (dry+wet ingredients), preferably 0% to 5% of the total mixture, more preferably 0.5% to 5% of the total mixture.

The dry ingredients can comprise an ingredient that is a legume flour. Non-limiting examples of suitable legume flours include flours from beans such as favas, lentils, mung beans, peas, chickpeas, and soybeans. Preferably legume flour, if any, is present in an amount of 0 to 15% of the total mixture (dry+wet ingredients), preferably 0.5% to 5% of the total mixture.

The dry ingredients can comprise an ingredient that is a starch. Non-limiting examples of suitable starch include cereal starch, such as those from rice, wheat, corn, barley, and sorghum; root vegetable starch, such as those from potato, cassava, sweet potato, arrowroot, yam, and taro; and other starches, such as sago, banana, plantain, and breadfruit starch. Preferably, the dry ingredients comprise the starch in an amount of 0% to 15% of the total mixture (dry+wet ingredients), preferably 0% to 5% of the total mixture, more preferably 0.5% to 5% of the total mixture.

Non-limiting examples of suitable plant lipid include soybean oil, corn oil, sunflower oil, high oleic sunflower oil, olive oil, canola oil, safflower oil, peanut oil, palm oil, cottonseed oil, coconut oil, almond oil, hazelnut oil, grapeseed oil, and combinations thereof. Preferably the wet ingredients comprise plant lipid in an amount of 0% to 14% of the total mixture (dry+wet ingredients), preferably 0.1% to 14% of the total mixture, preferably 2% to 10% of the total mixture.

The dry ingredients can also comprise one or more vitamins, minerals, flavors, and colors. Non-limiting examples of suitable flavors include yeast, tallow, and the like. Non-limiting examples of suitable colors include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan. Non-limiting examples of suitable vitamins include Vitamins A, B-complex (such as B-1, B-2, B-6 and B-12), C, D, E and K, niacin, and acid vitamins such as pantothenic acid, folic acid and biotin. Non-limiting examples of suitable minerals include calcium, iron, zinc, magnesium, iodine, copper, phosphorus, manganese, potassium, chromium, molybdenum, selenium, nickel, tin, silicon, vanadium, boron and the like.

Specific amounts for each additional ingredient will depend on a variety of factors such as the identity of the ingredient; the species of animal; the animal's age, body weight, general health, sex, and diet; the animal's consumption rate; the purpose for which the food product is administered to the animal; and the like. Therefore, the components and their amounts may vary widely.

Referring again to FIG. 1, the non-meat dough can be transferred, for example by pumping, from the mixing device in Step 102. Preferably the non-meat dough is transferred from the mixing device to a heating device. In Step 103, the non-meat dough can be heated by the heating device. In an embodiment, the non-meat dough is transferred directly from the mixing device to the heating device without any other processing such as extrusion or addition or removal of ingredients.

In an embodiment, the non-meat dough is uniformly mixed before the heating thereof. Therefore, the method 100 can comprise pre-emulsifying the non-meat dough before Step 103, for example by addition of an emulsifier during Step 101.

In an embodiment, the heating device is a high shear emulsifier (e.g. a pipe through which the non-meat dough passes, containing a rotor or impeller together with a stator), a heat exchanger (e.g. a concentric heat exchanger formed by two overlapping tubes), and/or a dielectric heater (e.g. radio frequency or microwave heating). Preferably the non-meat dough is heated to a temperature from 110□C to 180□C, more preferably 135□C to 165□C, most preferably 140□C to 160□C. Preferably the non-meat dough undergoes the heating at a pressure from 4.5 bar to 35 bar, preferably from 4.5 bar to 15 bar.

In Step 104, the pressure is maintained as the hot non-meat dough is transferred, for example by pumping, from the heating device. Preferably the hot non-meat dough is transferred from the heating device to a cooling device, such as a heat exchanger. In Step 105, the hot non-meat dough can be cooled (gradually cooled) by the cooling device. In an embodiment, the non-meat dough is transferred directly from the heating device to the cooling device without any other processing such as extrusion or addition or removal of ingredients.

Preferably a high pressure positive displacement pump is used to transfer the product from the heating device to the cooling device. The pump can control pressure at the outlet of the heating device to prevent moisture flashing and/or can provide pressure at the outlet of the pump to push the hot non-meat dough into and through the cooling device.

During the cooling in Step 105, both the temperature and the pressure are gradually reduced as the heated non-meat dough travels through the cooling device. The dough has moisture and is under elevated temperature, so preferably moisture flashing is controlled to avoid rapid expansion of the food product. Product expansion that is too rapid can disrupt the structure of the texturized food product. However, depending on the desired image of the final food product, some flashing may be required to reduce the temperature of the center of the food product and/or to expose some of the fibers in the food product. In an embodiment, the non-meat dough undergoes a decrease in pressure at a predetermine rate in the cooling device and/or is subjected to a predetermined final pressure at the end of the cooling device. In an embodiment the cooling is performed to a temperature of 50° C. to 110° C., preferably to a temperature of 60 to 100° C.

In Step 106, the texturized food product exiting the heat exchanger can be cut and/or shaped directly in-line or off-line. For example, an exit plate on the heat exchanger can shape the product as the product departs the heat exchanger. Each of the exit plates can have one or more orifices that impart a desired shape on the product travelling through the exit plate. Each exit plate is preferably directly attached to a corresponding outlet of the heat exchanger so that the product exiting the heat exchanger and being shaped by the exit plate occurs substantially simultaneously as one step.

As another example, one or more grids of static or vibrating knives can be attached on the heat exchanger. These knife grids can have vertical, horizontal and/or diagonal knives, depending on the shape of the food product to be manufactured. If more defined shapes are required, a cutting die with a more complex design can be fitted to each of the one or more outlets of the heat exchanger array.

In conjunction with the knife grids or cutting dies, if any, a rotating or similar type cross-cutting device can be attached. This cross-cutting device allows the exiting material to be cut to the required thickness or length. The speed of the cross-cutter can be automatically controlled depending on product flow rates, for example by a processor.

In Step 107, the protein snack product is dried. The drying is selected from air drying, microwave drying, freeze drying, vacuum belt drying, vacuum oven drying, vacuum microwave drying, vacuum infrared drying, dielectric drying, supercritical drying. In a preferably embodiment of the invention the drying is step is a vacuum drying step. The vacuum drying step helps to retain the desired shape and fibrous structure of the shelf-stable protein snack product. The vacuum drying is selected from vacuum belt drying, vacuum oven drying, vacuum microwave drying, vacuum infrared drying or combinations thereof. After drying the shelf-stable protein snack has a water activity less than 0.6, preferably less than 0.3. In an embodiment the shelf-stable protein snack has a size after drying with the dimension of length 20 to 100 mm, width 5 to 50 mm and thickness 0.1 to 20 mm.

In Step 108, the shelf-stable protein snack can be filled and sealed into a package. Non-limiting examples of suitable packaging types include cans, pouches, glass container, plastic containers.

In a preferred embodiment, the method 100 is completely free of an extrusion step, and the resultant shelf-stable protein snack is not made by extrusion.

### EXAMPLES

The invention is further described with reference to the following examples of ingredient mixes that can be used in the processes and/or methods provided by the present invention to result in a shelf-stable protein snack.

### Example 1

| Ingredient | % (w/w) |
|---|---|
| Water | 61 |
| Soy Protein concentrate | 31 |
| Plant lipid | 4 |
| Acid | 1 |
| Starch or Flour | 0 |
| Flavouring | 3 |
| Total Protein content | 21 |
| from concentrate | |

### Example 2

| Ingredient | % (w/w) |
|---|---|
| Water | 45 |
| Wheat Gluten | 38 |
| Plant lipid | 9 |
| Starch or Flour | 0 |
| Flavouring | 8 |
| Total Protein content | 27 |
| from concentrate | |

### Example 3

| Ingredient | % (w/w) |
|---|---|
| Water | 55 |
| Soy Protein concentrate | 31 |
| Plant lipid | 4 |
| Starch or Flour | 3 |
| Flavouring | 7 |
| Total Protein content | 21 |
| from concentrate | |

The resulted shelf-stable protein snacks from examples 1 to 3 have a fibrous appearance of real meat with a crunchy texture.

1. A process for preparing a shelf-stable protein snack comprising the steps of: mixing dry and wet ingredients comprising plant protein and water to form a non-meat dough; heating the non-meat dough under pressure; cooling, cutting and drying the heated non-meat dough, wherein the process is completely free of an extrusion step.

2. A process as claimed in claim 1 comprise the starch flour in an amount of 0% to 5% of the total mixture (dry+wet ingredients)

3. A process as claimed in claim 1 comprising pumping the non-meat dough from a device that performs the mixing to a device that performs the heating, without any processing there between.

4. A process as claimed in claim 1 comprising maintaining the pressure on the heated non-meat dough during transfer from a device that performs the heating to a device that performs the cooling, without any processing there between.

5. A process as claimed in claim 1, wherein the heating is performed by a device selected from the group consisting of a high shear emulsifier, a heat exchanger, and a dielectric heater.

6. A process as claimed in claim 1, wherein the non-meat dough resulting from the mixing has a moisture content of 40% to 67%.

7. A process as claimed in claim 1, wherein the wet ingredients further comprise plant lipid in an amount of 0% to 14% relative to the non-meat dough resulting from the mixing.

8. A process as claimed in claim 1, wherein the heating is performed at a temperature of 110° C. to 180° C.

9. A process as claimed in claim 1, wherein the non-meat dough undergoes the heating while at a pressure from 4.5 bar to 35 bar.

10. A process as claimed in claim 1, wherein the cooling is performed to a temperature of 50° C. to 110° C.

11. A process as claimed in claim 1, wherein the drying is selected from vacuum drying.

12. A process as claimed in claim 11, wherein the vacuum drying is a process selected from the group consisting of vacuum belt drying, vacuum oven drying, vacuum microwave drying, vacuum infrared drying and combinations thereof.

13. A shelf-stable protein snack obtainable by the process of claim 1.

14. A shelf-stable protein snack of claim 13 wherein the shelf-stable protein snack has a protein content of at least 40 wt % and a water activity less than 0.6.

15. A shelf-stable protein snack in claim 13 wherein the shelf-stable protein snack is formulated for the consumption by a human or by a pet.
